(19) United States
(12) Patent Application Publication
(10) Pub. No.: US 2024/0333719 A1
(43) Pub. Date: Oct. 3, 2024

(54) SYSTEMS AND METHODS FOR CONTROLLING ACCESS TO AN ELECTRONIC DEVICE

(71) Applicant: Apple Inc., Cupertino, CA (US)

(72) Inventor: David COHEN, Longmont, CO (US)

(21) Appl. No.: 18/611,432

(22) Filed: Mar. 20, 2024

Related U.S. Application Data
(60) Provisional application No. 63/493,293, filed on Mar. 30, 2023.

(51) Int. Cl. H04L 9/40

(52) U.S. Cl. CPC H04L 63/102

(57) ABSTRACT

A first user of an electronic device operates the electronic device in a first mode with access to a plurality of features. The first user optionally configures the electronic device to provide permission for another user to use the electronic device in a second mode with access to a subset of the plurality of features.

### CROSS-REFERENCE TO RELATED APPLICATIONS

This application claims the benefit of U.S. Provisional Application No. 63/493,293, filed Mar. 30, 2023, the contents of which are incorporated herein by reference in its entirety for all purposes.

### FIELD OF THE DISCLOSURE

Aspects of the present disclosure relate to authenticating a user and controlling access to an electronic device.

### BACKGROUND OF THE DISCLOSURE

Electronic devices grant and restrict access to features, such as applications and/or documents, based on user authentication. For example, access to various features is optionally granted in response to a user logging into the electronic device.

### SUMMARY OF THE DISCLOSURE

Aspects of the present disclosure relate to a first user granting a second user access to an electronic device in a second mode, and controlling access for the second user of the electronic device. An electronic device is associated with a first user (e.g., a first user account). While the first user is logged into the electronic device in a first mode, the electronic device allows the first user to access features, such as applications and/or documents, that are restricted when the first user is not logged into the electronic device. In some situations, the first user allows another user to use the electronic device with access to a subset of features in a second mode associated with a second user account (different from the first user account). For example, in the second mode, access is allowed for one or more applications of the electronic device, optionally a subset of the applications accessible to the first user in the first mode. Additionally, in the second mode access is allowed for one or more documents of the electronic device, optionally a subset of the documents accessible to the first user in the first mode (e.g., access to private documents of the first user is restricted). Once the first user allows access by the second user, access to features of the electronic device in the second mode for the second user is optionally granted upon authentication of the second user. Access to features of the electronic device for the second user in the second mode is optionally temporary (e.g., until restricted by the first user or other termination conditions are met).

### BRIEF DESCRIPTION OF THE DRAWINGS

For a better understanding of the various described embodiments, reference should be made to the Detailed Description below, in conjunction with the following drawings in which like reference numerals often refer to corresponding parts throughout the figures.

FIG. 1 illustrates a first electronic device communicatively coupled to one or more additional electronic devices according to some embodiments of the disclosure.

FIG. 2 illustrates an example user interface for configuring a second mode on the first electronic device according to some embodiments of the disclosure.

FIG. 3 is a block diagram illustrating a method of operating the first electronic device in a first mode or a second mode according to some embodiments of the disclosure.

FIG. 4 is an example block diagram of an electronic device according to some embodiments of the disclosure.

### DETAILED DESCRIPTION

Aspects of the present disclosure relate to a first user granting a second user access to an electronic device in a second mode, and controlling access for the second user of the electronic device. An electronic device is associated with a first user (e.g., a first user account). While the first user is logged into the electronic device in a first mode, the electronic device allows the first user to access features, such as applications and/or documents, that are restricted when the first user is not logged into the electronic device. In some situations, the first user allows another user to use the electronic device with access to a subset of features in a second mode associated with a second user account (different from the first user account). For example, in the second mode, access is allowed for one or more applications of the electronic device, optionally a subset of the applications accessible to the first user in the first mode. Additionally, in the second mode access is allowed for one or more documents of the electronic device, optionally a subset of the documents accessible to the first user in the first mode (e.g., access to private documents of the first user is restricted). Once the first user allows access by the second user, access to features of the electronic device in the second mode for the second user is optionally granted upon authentication of the second user. Access to features of the electronic device for the second user in the second mode is optionally temporary (e.g., until restricted by the first user or other termination conditions are met).

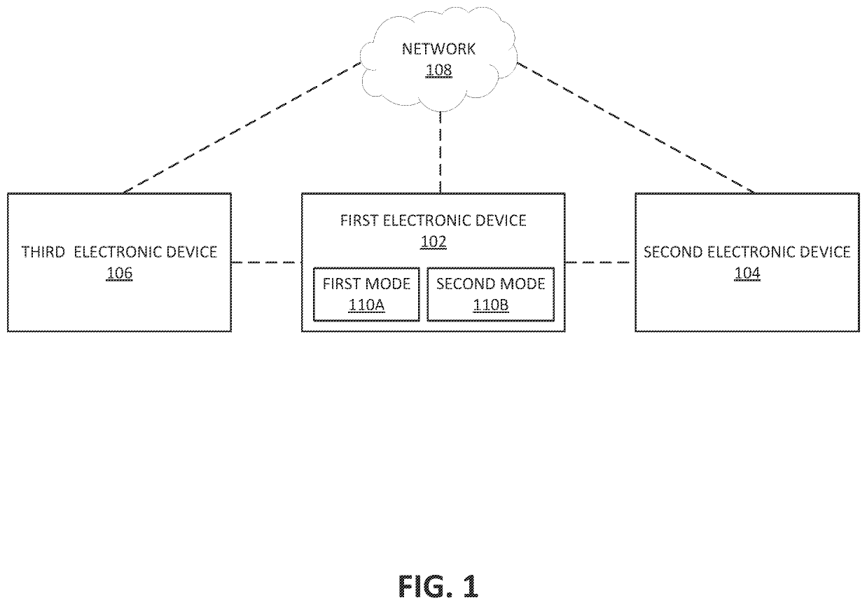

FIG. 1 illustrates a first electronic device, optionally communicatively coupled to one or more additional electronic devices, according to some embodiments of the disclosure. The first electronic device 102 optionally includes a mobile phone, a portable music player, a laptop computer, a desktop computer, a tablet computer, a television, or a wearable device (e.g., a watch, a wristband, a ring, an armband, a head-mounted display, etc.), among other possibilities. In some embodiments, first electronic device 102 is a wearable electronic device configured to automatically restrict access to features of the first electronic device 102 (e.g., automatically lock) when the first electronic device ceases to be worn.

As described herein, the first electronic device 102 is associated with a first user account. Access to one or more of features of the first electronic device, such as settings, files and/or applications (or other information), requires user authentication. Without authenticating the first user, the first electronic device 102 blocks access to the one or more features. Authentication of the first user for the first electronic device 102 optionally includes login credentials (e.g., a username and/or a password) and/or biometric authentication (e.g., fingerprint, iris scan, facial recognition, etc.). Additionally or alternatively, authentication of the first user for the first electronic device 102 optionally includes an authentication code sent to another electronic device associated with the first user account and/or detecting another electronic device associated with the first user account near (e.g., within communication range of) the first electronic device 102. For example, FIG. 1 illustrates a third electronic device 106 (e.g., a mobile phone, wearable device, etc.) associated with the first user account in communication with first electronic device 102 (e.g., directly or indirectly, such as via network 108). Third electronic device 106 optionally provides an authentication code or is otherwise detected by the first electronic device 102 to authenticate the first user and provide access to the one or more features of the first electronic device.

As described herein, a first user may operate the first electronic device 102 in a first mode 110A, but may also wish to allow a second user to use the first electronic device 102 in a second mode 110B, different from the first mode. To share a wearable device, for example, the first user removes the wearable device and the second user then wears the wearable device. An automatic lock feature of the first electronic device upon removal complicates access for the second user (e.g., locking requires another means to grant access to the second user). Accordingly, one aspect of the disclosure herein is methods to provide access to features and/or data of the first electronic device to the second user in a second mode (e.g., a guest mode).

To enable access for a second user, the first user configures a second mode on the first electronic device 102. The configuration optionally includes indicating a second user and/or one or more devices associated with the second user that have permission to access the first electronic device 102 in the second mode. For example, FIG. 1 illustrates a second electronic device 104 (e.g., a mobile phone, wearable device, etc.) associated with a second user account in communication with first electronic device 102 (e.g., directly or indirectly, such as via network 108). The configuration optionally includes indicating multiple other users and/or one or more other device(s) corresponding to the one or more multiple other users that have permission to access the first electronic device 102.

In some embodiments, the first electronic device 102 presents a plurality of options (e.g., selectable user interface elements), each corresponding to a user, from which the first user can select to grant access to the first electronic device 102 in the second mode. For example, the first electronic device 102 displays one or more options corresponding to one or more contacts of the first electronic device 102 and/or contacts of the first user account. As another example, the first electronic device 102 displays one or more options corresponding to one or more users that have previously used the first electronic device 102 in the second mode (or a subset of the one or more contacts that have previously used the first electronic device 102 in the second mode).

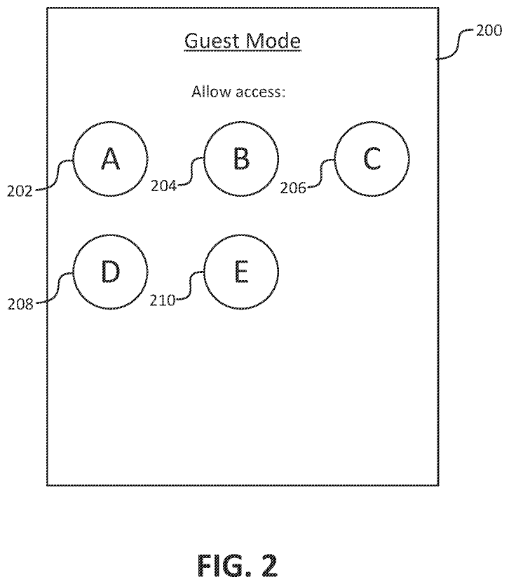

In some embodiments, the first electronic device 102 displays one or more options, each corresponding to an electronic device associated with another user, from which the first user can select to grant access to the first electronic device 102 in the second mode. For example, the one or more options correspond to electronic devices that are currently in communication range of the first electronic device 102 or in communication with the first electronic device 102 directly or indirectly, such as via network 108 (e.g., Bluetooth, Wi-Fi, near field communication, etc.). As another example, the one or more options additionally or alternatively correspond to devices that were previously in communication range of the first electronic device 102 (e.g., devices that are frequently in communication range of the first electronic device 102, or devices associated with previous users of the first electronic device 102 in the second mode). An example user interface for selecting one or more devices that have permission to access the first electronic device 102 in the second mode is shown in FIG. 2 and described in more detail below.

In addition to selecting users to grant access to the first electronic device 102 in the second mode, the configuration optionally includes selecting available authentication options for the second user to access the first electronic device 102 in the second mode. For example, the first electronic device 102 displays options for available authentication means to initiate the second mode from which the first user can select as part of the configuration of the second mode. Authentication options for the second user optionally includes login credentials (e.g., a username and/or a password for the second user) and/or biometric authentication (e.g., fingerprint, iris scan, facial recognition, etc. for the second user). Additionally or alternatively, authentication for the second user optionally includes an authentication code sent to an electronic device associated with the second user account (e.g., second electronic device 104), and/or detecting the second electronic device 104 associated with the second user account near (e.g., within communication range of) the first electronic device 102 or on the same network 108 (e.g., Wi-Fi network) as first electronic device 102.

Additionally or alternatively, the configuration options include selecting which features of the electronic device 102 should be accessible to the second user in the second mode 110B. The first electronic device 102 presents options and/or toggles allowing the first user to select files, applications, and/or particular features of applications that will be accessible to the second user in the second mode, with other files, application, and/or particular features of applications being restricted. The first electronic device 102 allows different permissions in the second mode for different guest users. For example, the first electronic device 102 is configured to allow a second user to access a first set of features in the second mode, with other features being restricted, and configured to allow a third user to access a second set of features in the second mode that are different from the first set of features, with other features being restricted.

After configuration of the second mode, the second user accesses the first electronic device 102 by authentication of the second user. In some embodiments, the first electronic device 102 indicates to the second user a plurality of available authentication options for accessing the first electronic device 102 in the second mode. For example, the first electronic device 102 displays a prompt for the second user to input a username and/or a password for the second user, or prompts the second user to enter an authentication code. In some embodiments, the first electronic device 102 initiates biometric authentication or detects the second electronic device 104 near the first electronic device 102.

In some embodiments, the authentication modality that the first electronic device 102 uses to authenticate the first user is different from the authentication modality that the first electronic device 102 uses to authenticate the second user. For example, the first electronic device 102 optionally authenticates the first user using biometrics of the first user and authenticates the second user based on the first electronic device 102 being in communication with the second electronic device 104 or within communication distance of the second electronic device 104. In some embodiments, the authentication modality that the first electronic device 102 uses to authenticate the second user for a first session of the second mode is different from the authentication modality that the first electronic device 102 uses to authenticate the second user for a subsequent session of the second mode. For example, the first electronic device 102 optionally authenticates the second user based on the first electronic device 102 being in communication with the second electronic device 104 or within communication distance of the second electronic device 104 for an initial session of the second mode (e.g., during which biometrics of the second user are configured but inaccessible to the first electronic device) and authenticates the second user using biometrics of the second user for a subsequent session.

In some embodiments in which first electronic device 102 is a wearable device or includes a wearable component (e.g., a headset or head mounted display), upon detecting a person wear the wearable device or component, the first electronic device 102 presents a lock screen user interface. The first electronic device 102 attempts to authenticate the user while displaying the lock screen user interface in one or more manners described herein. The lock screen user interface optionally includes a selectable option that, when selected, causes the first electronic device 102 to operate in the second mode 110B. The first electronic device 102 optionally enters the second mode in response to detecting selection of the option and authenticating the user as a user that has permission to use the first electronic device 102 in the second mode. The first electronic device 102 optionally enters the second mode in response to detecting selection of the option and receiving an indication from the third electronic device 106 granting permission for the other user to use the first electronic device 102 in the second mode.

In some embodiments, in addition to authenticating the second user for access to the first electronic device 102, access is optionally dependent on further permission by the first user. For example, when the second user initiates a session in the second mode, the first electronic device 102 transmits a notification to another electronic device associated with the first user's account (e.g., third electronic device 106) indicating that the second user is using or attempting to access the first electronic device 102 in the second mode. Optionally, the other electronic device (e.g., third electronic device 106) presents a prompt with options to grant or deny the second user access to the first electronic device 102. The prompt optionally includes visual, audio, or haptic aspects that provide the first user the opportunity to grant or deny access (e.g., by pressing a button, performing a gesture, providing a voice command, etc.). In some embodiments, the first user must grant access via the prompt options to provide access to the second user. In some embodiments, the second user is provided access when the first user does not provide an input to deny access in response to the prompt. Optionally, the prompt includes an option to access settings to revoke permissions for the second user (e.g., a particular second user or other users outside of the first user).

When the first user denies access, the second user is unable to access the first electronic device 102. In some embodiments, in response to receiving a request from the first user (e.g., from third electronic device 106) to deny access to the second mode, the first electronic device 102 terminates an ongoing session of the second mode. Optionally, revoking permission for the second user also blocks the second user from accessing the first electronic device 102 unless and until the first user restores access permissions to the second user (e.g., after the first user initiates an authenticated session in the first mode on the first electronic device 102 and passes the first electronic device 102 to the second user, or after the first user remotely restores access to the second user for the first electronic device 102 using third electronic device 106 associated with the first user's account).

In some embodiments, access to the first electronic device 102 by the second user in the second mode requires the first electronic device 102 to remain connected to an internet connection or other network connection (e.g., network 108). For example, when a Wi-Fi or other network connection becomes disconnected during the second mode, the first electronic device 102 terminates the second mode (or locks the device in the second mode) immediately. As another example, the first electronic device 102 terminates the second mode (or locks) after the Wi-Fi or other network connection remains disconnected beyond a grace period of time (e.g., 1, 2, 5, or 10 minutes) without the connection being restored. In this situation, when the connection is restored within the grace period of time, the first electronic device 102 does not terminate the second mode or lock the second device. Additionally, in some embodiments, some features of the first electronic device 102 that are enabled for the second user in the second mode become disabled while the connection is lost. Optionally, these features become re-enabled if the network connection is restored within a predetermined grace period of time.

Permission to access the first electronic device 102 by the second user is optionally premised on a trustworthiness of the second user (e.g., a level of trust the first user assigns to the second user). The level of trustworthiness assigned to a second user is optionally persistent (e.g., enabling access to the second mode until revoked). The level of trustworthiness assigned to a second user is optionally one-time (e.g., enabling access to the second mode for a single session). The level of trustworthiness assigned to a second user is optionally semi-persistent (e.g., enabling access for a defined amount of time, a defined number of sessions, or while the first electronic device 102 remains connected to network 108).

The level of trustworthiness optionally controls access capabilities for features of the first electronic device. For example, a first, relatively higher level of trustworthiness permits access to the plurality of features of the first electronic device 102 (e.g., the same features accessible to the first user in the first mode). A second, relatively lower level of trustworthiness permits access to a subset of the plurality of features of the first electronic device 102. Additional details regarding access to features of the first electronic device 102 are described in more detail below.

The level of trustworthiness optionally controls the types of access permission that the second user needs from the first user to access the first electronic device 102 in the second mode. For example, the first user optionally receives a prompt each time the second user attempts to access the first electronic device (e.g., for each session of the second mode). Optionally, the first user receives a prompt each time the second user attempts to access the first electronic device after the first electronic device 102 is idle for a predetermined amount of time (e.g., 5 minutes, 10 minutes, 30 minutes, one hour). Thus, the second user can take breaks from operating the first electronic device 102 in the second mode without requiring the first user to again provide access to the first electronic device 102.

Optionally, the prompts are not required for a trustworthy second user, or frequency of the prompts is reduced for a trustworthy second user compared with a less trustworthy second user. For example, the first user of the first electronic device 102 optionally enables the second user with a first, relatively higher level of trustworthiness to unlock the first electronic device 102 using one of the authentication modalities described above without prompting the first user to an access attempt by the second user (or with less frequent prompts compared with second user with a lower level of trustworthiness (e.g., one prompt per day)).

In some embodiments, a second user with a lower level of trustworthiness is required to enter into at least an initial session of the second mode on the first electronic device 102 that is enabled “in-person” by the first user. For example, to provide access to the second mode, the first user unlocks the first electronic device 102 (e.g., while wearing first electronic device 102) using one of the authentication modalities described above and provides one or more inputs granting permission to access the second mode (e.g., selects the second user or second user device as described with respect to FIG. 2). Thereafter, the first user ceases using (e.g., ceases wearing) the first electronic device, and the second user is optionally required to unlock the first electronic device 102 (e.g., while wearing first electronic device 102) using one of the authentication modalities described above, within a threshold period of time (e.g., within 1 minutes, 5 minutes, 10 minutes) of the first user granting permission.

As an alternative, the second user optionally accesses the second mode without authentication of the second user in a situation that the second mode begins nearly immediately following configuration of the second mode by the first user in the first mode. For example, after the first user configures the second mode to provide permission to the second user, the first user ceases operation of the first electronic device 102 (e.g., ceases wearing the first electronic device 102 and passes the first electronic device 102 to the second user). Thereafter, the second user has a predetermined period of time (e.g., 30 seconds, 1 minute, 2 minutes) to initiate a session of use of the first device in the second mode (e.g., wearing the first electronic device 102).

Additionally or alternatively, in some embodiments, a second user with a lower level of trustworthiness is required to enter into at least an initial session of the second mode on the first electronic device 102 while co-located with the first user. Co-location is optionally determined based on network connection and/or distance. For example, the second user is optionally required to unlock the first electronic device 102 (e.g., while wearing first electronic device 102) using one of the authentication modalities described above while the first electronic device 102 remains on the same network (e.g., network 108) as used by the first user in the first mode and/or while the first user remains within a threshold distance of the first electronic device 102 (e.g., while third electronic device 106 associated with the first user account remains within a threshold distance (e.g., 10 meters, 25 meters, etc.) of the first electronic device 102 or remains on the same network with the first electronic device 102).

In some embodiments, the level of trustworthiness optionally controls whether the first user needs to remain co-located with (within a threshold distance of) the first electronic device 102 in the second mode. For example, for a second user of a first, relatively higher level of trustworthiness, the first electronic device optionally maintains the second session even without a co-located first user (e.g., the first user is outside of a threshold distance). For a second user of a second, relatively lower level of trustworthiness, however, a session of the second mode on the first electronic device 102 is optionally terminated when the first user is outside a threshold distance from the second user. For example, the first user is optionally determined to be within a threshold distance (e.g., 10 meters, 25 meters, etc.) of the first electronic device 102 while another electronic device associated with the first user's account (e.g., third electronic device 106) remains within a threshold distance of the first electronic device 102 or remains on the same communication network with the first electronic device 102 (e.g., same Wi-Fi network 108). Thus, when the first user is determined to have left the second user unsupervised with the first electronic device, such a session is terminated for this less trustworthy second user. Optionally, the session is not terminated once the first user is outside the threshold distance, but a subsequent session of the second mode cannot be initiated (or requires new permissions from the first user).

In some embodiments, the level of trustworthiness optionally controls whether the first electronic device 102 needs to maintain a network connection for operation in the second mode. For example, a second user of a first, relatively higher level of trustworthiness the first class of second user is optionally able to continue using the first electronic device 102 in the second mode when the network connection becomes disconnected, whereas the second user of a second, relatively lower level of trustworthiness is optionally unable to continue using the first electronic device 102 in the second mode when the network connection becomes disconnected (e.g., the first electronic device 102 terminates the second session). In situations in which the first user provides in-person authorization for the second user to use the first electronic device at the beginning of a session in the second mode, the first electronic device optionally does not require network connection (regardless of level of trustworthiness) because the first user provided authorization in person for the session. Alternatively, the loss of a network connection causes the second mode to be restricted (e.g., fewer accessible features, terminated) regardless of level of trustworthiness of the second user. However, once the Wi-Fi or other network connection is restored, the first electronic device 102 allows the second user of the first, relatively higher level of trustworthiness to resume the second mode or start a new session in the second mode without requiring input from the first user (whereas new permissions from the first user are required to resume or start a new session for a second user of a second, lower level of trustworthiness).

In some embodiments, at the conclusion of a session of the second mode for the second user, the first electronic device 102 presents the first user with a prompt to change the level of trustworthiness of the second user (e.g., to provide more or less restrictive access to the first electronic device 102) or to change the persistence of the level of trustworthiness.

As described herein, access to features of the first electronic device by the first user in the first mode is different than the access to features of the first electronic device by the second user in the second mode. For example, the second mode 110B includes access to a more limited feature set compared to the features accessible to the first user of the first electronic device 102 in the first mode 110A. For example, the first user optionally has access to all applications on the first electronic device 102 in the first mode, whereas the second user has access to a subset of applications on the first electronic device 102 in the second mode. Additionally or alternatively, the first user optionally has access to more features of the applications on the first electronic device 102 in the first mode, whereas the second user has access to a subset of features of the applications on the first electronic device 102 in the second mode. For example, payment features of a payment application may be unavailable to the second user or may require the second user to provide payment information of the second user to access this feature. As another example, the communication sessions using the first electronic device are optionally restricted for the second user such that a representation of the first user (e.g., an image or avatar) cannot be used in the second mode. Additionally or alternatively, the first user optionally has access to all documents and files on the first electronic device 102 in the first mode, whereas the second user has access to a subset of the documents and files (or no documents and files associated with the first user account) on the first electronic device 102 in the second mode (e.g., the first user's data is hidden, encrypted, or otherwise inaccessible by the second user). As a further example, while in the second mode, the second user is optionally unable to save files and/or configurations of the first electronic device 102 to be stored in memory of the first electronic device 102 at the conclusion of the session of the second mode. As another example, while in the second mode, the second user is able to access (e.g., run) one or more applications (e.g., access application binaries), but is unable to access the first user's user data associated with the applications. In this example, the first user is able to access the user data while the first electronic device is in the first mode. In such examples, the second mode is not merely a different user profile or login account of the first electronic device 102 with the same features and permissions as the first user account.

FIG. 2 illustrates an example user interface 200 for configuring a second mode on the first electronic device 102 according to some embodiments of the disclosure. The first electronic device 102 uses a display device to display the user interface 200. The first electronic device 102 optionally displays the user interface 200 in a two-dimensional environment or in a three-dimensional environment (e.g., an extended reality environment).

As described herein, prior to initiating the second mode, the first user provides the first electronic device 102 with a list of users and/or electronic devices that have permission to access the second mode when the first electronic device 102 is locked. The first user optionally configures the second mode by selecting one or more other electronic devices, such as second electronic device 104 in FIG. 1, whose corresponding user account(s) are to have permission to enter the second mode (e.g., with authentication). For example, as shown in FIG. 2, the user interface 200 includes options 202-210 corresponding to other electronic devices (e.g., nearby electronic devices). In response to detecting selection of one or more of options 202-210, the first electronic device 102 optionally grants permission to the user accounts corresponding to the selected devices to access the first electronic device 102 in the second mode. User accounts corresponding to non-selected electronic devices are not granted permission by the first electronic device 102 to access to the second mode.

In some embodiments, in addition to selection of electronic devices (corresponding to second users) to grant permission to access the first electronic device 102 in the second mode, the user interface provides an option to select a level of trust (e.g., second user access rights). Optionally, selection of a particular user automatically assigns a default level of trust, and a different user interface is optionally used to change the level of trust.

As described herein, options 202-210 correspond to other electronic devices currently in communication range of the first electronic device 102, electronic devices that have previously communicated with the first electronic device 102, and/or electronic devices that have previously connected to the first electronic device 102 during the second mode. Additionally or alternatively, options 202-210 correspond to other electronic devices associated with other user accounts that are contacts of the first user and/or members of a group of accounts to which the first user account belongs or administers. For example, the first electronic device 102 optionally displays one or more options corresponding to members of a family account group, a corporate account group (e.g., members or employees of an organization), or a group of students and/or school staff. The first electronic device 102 is optionally configured to allow members of the group of user accounts that includes the first user account to access the first electronic device 102 in the second mode automatically without selecting each of the users in the user account group.

In some embodiments, in response to detecting selection of one or more of the options 202-210, the first electronic device 102 transmits an authentication file (e.g., a key) and/or a link (e.g., Uniform Resource Locator (URL)) to the selected device (or devices) to enable the selected device to unlock the first electronic device 102 and operate in the second mode. For example, the first electronic device 102 sends a message to the other device (e.g., second electronic device 104) including the authentication file and/or URL. The URL optionally corresponds to an address at which the second user of the selected electronic device can register their device to access the first electronic device 102 in the second mode. Once the selected electronic device has the authentication code and/or once the second user of the selected device completes the registration, the selected device is able to unlock the first electronic device 102 in the second mode.

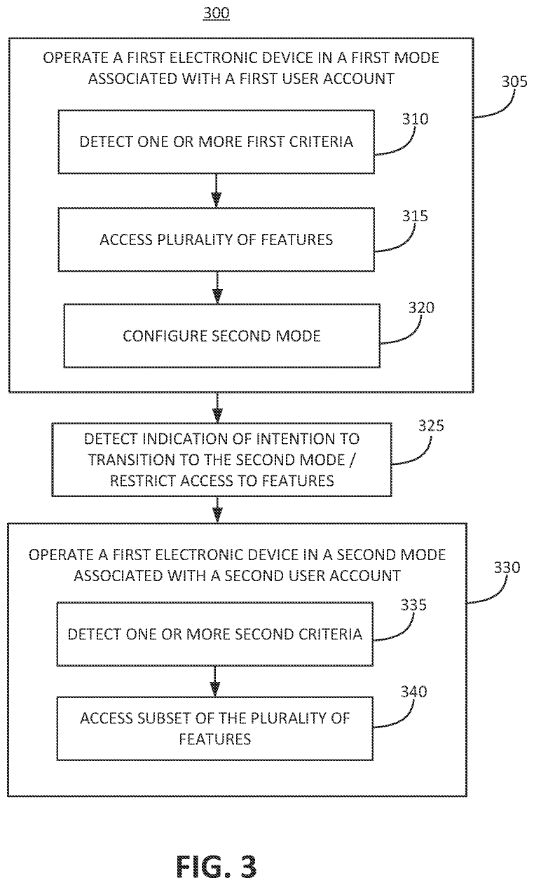

FIG. 3 is a block diagram 300 illustrating a method of operating the first electronic device 102 in a first mode or a second mode according to some embodiments of the disclosure. At block 305, the first user operates the first electronic device 102 in the first mode 110A. For example, in the first mode, the first electronic device 102 detects authentication of the first user at block 310, and authentication of the first user enables access to a plurality of features (e.g., applications, settings, files, data, etc.) at block 315. The authentication at block 310 optionally corresponds to satisfaction of one or more first criteria (e.g., corresponding to authentication conditions for the first user). Example authentication modalities available for the first user to log into the first electronic device 102 include a password, biometrics, an authentication code received from another electronic device (e.g., third electronic device 106) associated with the first user account, and/or detecting another electronic device (e.g., third electronic device 106) associated with the first user account near (e.g., within communication range of) the first electronic device 102, as described herein. Without authentication of the first user (e.g., without satisfaction of the one or more first criteria), the first electronic device 102 remains locked with access to the plurality of features restricted. At block 320, the first electronic device 102 is optionally configured for a second mode of access for the first electronic device 102 as described herein. The configuration process grants permission for the second user to access the device after authentication of the second user. Without configuration of the second mode, a second user cannot access the first electronic device in the second mode.

At block 325, the first electronic device 102 detect an indication of possible intention of the first user to transition the first electronic device 102 from operation in the first mode to operation in the second mode. For example, for a wearable device, detecting the indication optionally corresponds to ceasing wearing the first electronic device 102 (e.g., removing, in the first mode, first electronic device 102 from the body). As another example, detecting the indication includes detecting the first user log out of their user account on the first electronic device 102 and/or the first electronic device 102 automatically locking. In some situations, as described herein, the indication causes an end of the first mode and/or restricts access to the plurality of features (e.g., until the first user is again authenticated to use the first electronic device in the first mode or the second user is authenticated to use the first electronic device in the second mode). In some situations, as described herein, ceasing wearing the first electronic device 102 does not restrict access to the plurality of features when the second user is authenticated to use the first electronic device (e.g., within a predetermined period of time after detecting ceasing wearing the first electronic device 102 by the first user operating the first mode).

At block 330, the second user operates the first electronic device 102 in the second mode 110B. For example, to enter the second mode, the first electronic device 102 detects authentication of the second user at block 335, and authentication of the second user enables access to a subset of the plurality of features (e.g., a subset of the applications, settings, files, data, etc. as described herein) in the second mode at block 340. The authentication at block 335 optionally corresponds to satisfaction of one or more second criteria (e.g., corresponding to authentication conditions for the second user). Authentication modalities available for the second user are optionally the same as those available for the first user, or are optionally different. For example, authentication optionally includes proximity of a second electronic device 104 associated with the second user to the first electronic device 102. Additionally or alternatively, the one or more second criteria include a criterion that is satisfied when the second mode is initiated with permission of the first user (e.g., at block 320 with selection of the second user or a device associated with the second user). Additionally or alternatively, the one or more second criteria include a criterion that is satisfied when the user authorizes or does not deny access to the second user via a prompt presented on another electronic device associated with the first user's account (e.g., third electronic device 106). Without authentication of the second user (e.g., without satisfaction of the one or more second criteria), the first electronic device 102 remains locked with access to the plurality of features restricted.

Block diagram 300 is an example method the first electronic device 102 performs in accordance with the disclosure. Variations of this method are possible without departing from the scope of the disclosure. For example, the first electronic device 102 optionally performs one or more additional operations and/or repeat, skip and/or perform one or more of the operations described herein in a different order than the order described without departing from the scope of the disclosure.

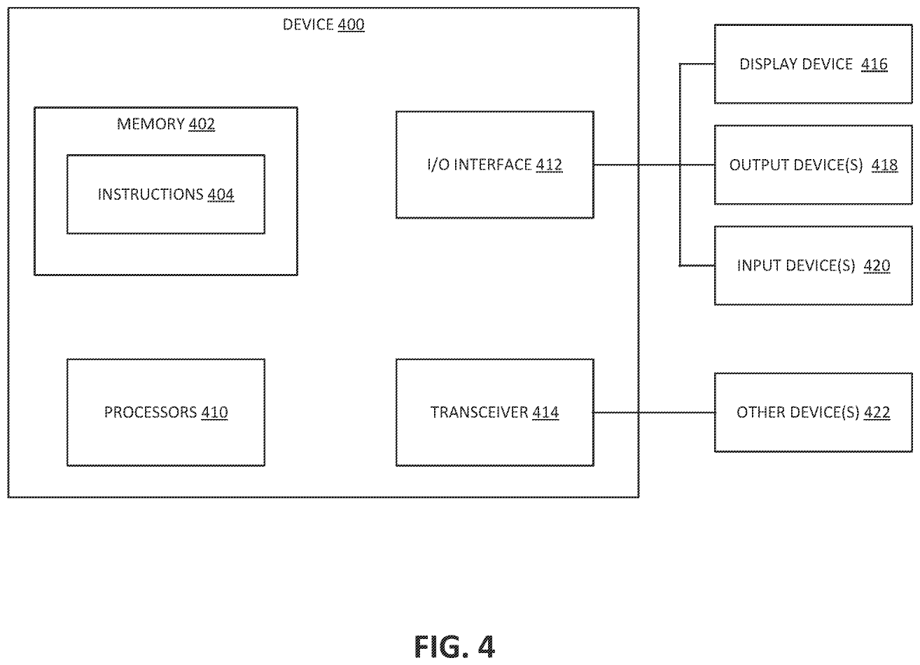

FIG. 4 is an example block diagram of an electronic device 400 according to some embodiments of the disclosure. The first electronic device 102, second electronic device 104, and/or third electronic device 106 described above with reference to FIG. 1 optionally share the same architecture as electronic device 400. However, it is possible for the first electronic device 102, second electronic device 104, and/or third electronic device 106 to include more, fewer, or different components than shown in the architecture of electronic device 400. The electronic device 400 includes memory 402, one or more processors 410, I/O interface 412, and transceiver 414.

Memory 402 of electronic device 400 includes volatile and/or non-volatile memory implemented using electronic, electromagnetic, magnetic, infrared, optical, and/or semiconductor system(s) and/or device(s). Examples of suitable memory circuitry include random access memory (RAM) devices (e.g., static random-access memory (SRAM), double-data-rate random-access memory (DDR RAM), dynamic random-access memory (DRAM), or other high-speed RAM or solid-state RAM, etc.), flash memory devices, read-only memory (ROM) devices, or erasable or electrically erasable programmable read-only memory devices (EPROM or EEPROM). Other types of memory are possible. Memory 402 is optionally separate from the one or more other components of electronic device 400 and electrically coupled to the one or more other components of electronic device 400 for read and/or write operations. Some of memory 402 is optionally integrated within other components of electronic device 400.

At least a portion of the memory 402 can be referred as a computer-readable storage medium. Memory 402 and/or a transitory or non-transitory computer readable storage medium of memory 402 optionally store instructions, programs, data structures and/or modules or a subset or combination thereof. Memory 402 and/or the computer readable storage medium optionally store instructions 404 and/or programs, which when executed by processors 410, cause the electronic device 400 (or a computing system more generally) to perform one or more functions and methods of one or more examples of this disclosure, such as one or more of the methods described herein with reference to FIGS. 1-3. As used herein, a “non-transitory computer-readable storage medium” includes any tangible medium (e.g., excluding signals) that can contain or store programs/instructions for use by the electronic device (e.g., processing circuitry), for example.

The electronic device 400 further includes one or more processors 410. Processors 410 optionally include graphics processing units (GPUs), central processing units (CPUs), microprocessors, microcontrollers, programmable logic device (PLD), field-programmable gate arrays (FPGAs), application specific integrated circuits (ASICs), digital signal processors (DSPs), or any suitable processing circuitry. The electronic device 400 uses processors 410 to perform any of the functions, processes, and/or methods described herein (e.g., optionally by executing instructions or programs stored in memory 402 and/or a non-transitory computer-readable storage medium).

The electronic device 400 further includes an I/O interface 412. I/O interface 412 includes circuitry such as data lines, address lines, and control lines, for example, that enables communication between the electronic device 400 and one or more peripherals, such as display device 416, output device(s) 418, and input device(s) 420. Example display devices include, but are not limited to, monitors, television screens, touch screens, projectors, and/or head mounted displays implemented with LCD (liquid crystal display), LED (light emitting diode), OLED (organic light emitting diode), and/or other technology. Examples of other output device(s) 418 include, but are not limited to audio output devices (e.g., wired and/or wireless speakers and/or headphones), tactile output devices (e.g., haptic and/or vibration devices), and other visual output devices (e.g., indicator lights). Example input device(s) 420 include camera(s) (e.g., visible light cameras and/or infrared cameras), depth sensors (e.g., range sensors and/or LiDAR), trackpads, mouses, touch screens, microphones, keyboards, pedals, remote controls, and/or video game controllers.

The electronic device 400 includes a transceiver 414 (e.g., wired and/or wireless communication circuitry). Transceiver 414 includes transmitter and/or receiver circuitry, including but not limited to signal generator(s), oscillator(s), modulator(s), encoder(s), amplifier(s), antenna(s), demodulator(s), filter(s), decoder(s), and/or tuner(s), for example. In some embodiments, the transceiver 414 is configured to communicate with other device(s) 422 using one or more protocols, including but not limited to, Bluetooth, Wi-Fi, Wi-Fi Direct, radio, cellular communication, satellite communication, and/or wired communication.

As described above, the components and configuration of components of electronic device 400 according to the disclosure are not limited by the example illustrated and described with reference to FIG. 4. In some embodiments, one or more of the components of the electronic device 400 included in FIG. 4 and any additional components of the electronic device 400 not shown in FIG. 4 are in communication with each other and/or integrated with each other. In some embodiments, additional or alternative components and/or configurations are possible.

Aspects of the disclosure relate to communication between electronic devices. Handling of information included in this communication should meet or exceed privacy practices according to their relevant industry and/or government regulations. In some embodiments, sharing of personal information can be blocked and/or prevented without departing from the scope of the disclosure. For example, users may opt out of sharing personal information when allowing devices to communicate and/or authentication modalities other than communication between devices can be used.

Some embodiments of the disclosure are related to an electronic device comprising memory; and one or more processors coupled to the memory, the one or more processors configured to while operating in a first mode associated with a user account of the electronic device: while access to a plurality of features is restricted, detect that one or more first criteria are satisfied; and in accordance with detecting that the one or more first criteria are satisfied, allow access to the plurality of features; and while operating in a second mode different from the first mode, the second mode associated with a second user account different from the user account of the electronic device: while access to the plurality of features is restricted, detect that one or more second criteria are satisfied, the one or more second criteria different from the one or more first criteria; and in accordance with detecting that the one or more second criteria are satisfied, allow access to a first subset of the plurality of features while continuing to restrict access to a second subset of the plurality of features. Additionally or alternatively, in some embodiments the one or more processors are further configured to: while operating in the first mode associated with the user account of the electronic device: while allowing access to the plurality of features, detect one or more third criteria are satisfied, the one or more third criteria different from the one or more first criteria and different form the one or more second criteria; and in accordance with detecting that the one or more third criteria are satisfied, restrict access to the plurality of features without a delay of a predetermined time period; and while operating in the second mode associated with the second user account: while allowing access to the first subset of the plurality of features, detect the one or more third criteria are satisfied; and in accordance with detecting that the one or more third criteria are satisfied, restrict access to the first subset of the plurality of features after the delay of the predetermined time period. Additionally or alternatively, in some embodiments the electronic device further includes one or more input devices, wherein the one or more processors are further configured to, while operating in the first mode associated with the user account of the electronic device: receive, using the one or more input devices, an input corresponding to a request to enable the second user account to access the electronic device in the second mode. Additionally or alternatively, in some embodiments the electronic device further includes one or more output devices, wherein the one or more processors are further configured to present, using the one or more output devices, one or more representations of electronic devices near the electronic device, including a representation of a second electronic device associated with the second user account, wherein receiving the input corresponding to the request to enable the second user account to access the electronic device in the second mode includes detecting selection of the representation of the second electronic device associated with the second user account, and wherein operating in the second mode is in response to detecting proximity of the second electronic device. Additionally or alternatively, in some embodiments the electronic device further includes one or more output devices, wherein the one or more processors are further configured to: present, using the one or more output devices, one or more representations of user accounts that are contacts of the electronic device, including a representation of the second user account, wherein receiving the input corresponding to the request to enable the second user account to access the electronic device in the second mode includes detecting selection of the representation of the second user account, and in response to detecting selection of the representation of the second user account, transmit a universal resource locator (URL) to the second user account that permits access to the electronic device in the second mode. Additionally or alternatively, in some embodiments the electronic device further includes one or more output devices, wherein the one or more processors are further configured to: present, using the one or more output devices, one or more representations of electronic devices that previously connected to the electronic device including a representation of a second electronic device associated with the second user account, wherein receiving the input corresponding to the request to enable the second user account to access the second electronic device in the second mode includes detecting selection of the representation of the second electronic device. Additionally or alternatively, in some embodiments the one or more first criteria include a criterion that is satisfied when the first user is authenticated using a first authentication modality, and the one or more second criteria include a criterion that is satisfied when the second user is authenticated using a second authentication modality different from the first authentication modality. Additionally or alternatively, in some embodiments the one or more processors are configured to: while operating in the second mode associated with the second user account: while access to the first subset of the plurality of features is enabled, receive, from a second electronic device associated with the user account of the electronic device, an indication corresponding to a request to restrict access to the first subset of the plurality of features; and in response to receiving the indication from the second electronic device, restrict access to the first subset of the plurality of features. Additionally or alternatively, in some embodiments the one or more processors are further configured to: while operating in the second mode associated with the second user account: while connected to an internet connection, allow access to the first subset of the plurality of features; and in accordance with detecting that the internet connection is disconnected, restrict access to the first subset of the plurality of features. Additionally or alternatively, in some embodiments the one or more processors are further configured to: while operating in the second mode associated with the second user account, transmit, to a second electronic device associated with the user account, an indication that the second user is accessing the electronic device in the second mode. Additionally or alternatively, in some embodiments the electronic device further includes a head-mounted display, wherein the one or more second criteria include a criterion that is satisfied when a mobile device associated with the second user account is in communication with the electronic device, wherein the mobile device associated with the second user account is a smartphone or a wearable device that does not include a head-mounted display. Additionally or alternatively, in some embodiments the mobile device is the wearable device, and the one or more second criteria include a criterion that is satisfied when the second user is wearing the wearable device and is not satisfied when the second user is not wearing the wearable device.

Some embodiments are directed to a method performed at an electronic device that includes memory and one or more processors coupled to the memory, the method comprising: while operating in a first mode associated with a user account of the electronic device: while access to a plurality of features is restricted, detecting that one or more first criteria are satisfied; and in accordance with detecting that the one or more first criteria are satisfied, allowing access to the plurality of features; and while operating in a second mode different from the first mode, the second mode associated with a second user account different from the user account of the electronic device: while access to the plurality of features is restricted, detecting that one or more second criteria are satisfied, the one or more second criteria different from the one or more first criteria; and in accordance with detecting that the one or more second criteria are satisfied, allowing access to a first subset of the plurality of features while continuing to restrict access to a second subset of the plurality of features. Additionally or alternatively, in some embodiments, the method further includes while operating in the first mode associated with the user account of the electronic device, while allowing access to the plurality of features, detecting one or more third criteria are satisfied, the one or more third criteria different from the one or more first criteria and different form the one or more second criteria; and in accordance with detecting that the one or more third criteria are satisfied, restricting access to the plurality of features without a delay of a predetermined time period; and while operating in the second mode associated with the second user account: while allowing access to the first subset of the plurality of features, detecting the one or more third criteria are satisfied; and in accordance with detecting that the one or more third criteria are satisfied, restricting access to the first subset of the plurality of features after the delay of the predetermined time period. Additionally or alternatively, in some embodiments the method further includes while operating in the first mode associated with the user account of the electronic device, receiving, using one or more input devices, an input corresponding to a request to enable the second user account to access the electronic device in the second mode. Additionally or alternatively, in some embodiments the method further includes presenting, using one or more output devices, one or more representations of electronic devices near the electronic device, including a representation of a second electronic device associated with the second user account, wherein receiving the input corresponding to the request to enable the second user account to access the electronic device in the second mode includes detecting selection of the representation of the second electronic device associated with the second user account, and wherein operating in the second mode is in response to detecting proximity of the second electronic device. Additionally or alternatively, in some embodiments the method further includes presenting, using one or more output devices, one or more representations of user accounts that are contacts of the electronic device, including a representation of the second user account, wherein receiving the input corresponding to the request to enable the second user account to access the electronic device in the second mode includes detecting selection of the representation of the second user account, and in response to detecting selection of the representation of the second user account, transmitting a universal resource locator (URL) to the second user account that permits access to the electronic device in the second mode. Additionally or alternatively, in some embodiments the method further includes presenting, using one or more output devices, one or more representations of electronic devices that previously connected to the electronic device including a representation of a second electronic device associated with the second user account, wherein receiving the input corresponding to the request to enable the second user account to access the second electronic device in the second mode includes detecting selection of the representation of the second electronic device. Additionally or alternatively, in some embodiments the one or more first criteria include a criterion that is satisfied when the first user is authenticated using a first authentication modality, and the one or more second criteria include a criterion that is satisfied when the second user is authenticated using a second authentication modality different from the first authentication modality. Additionally or alternatively, in some embodiments the method further includes while operating in the second mode associated with the second user account, while access to the first subset of the plurality of features is enabled, receiving, from a second electronic device associated with the user account of the electronic device, an indication corresponding to a request to restrict access to the first subset of the plurality of features; and in response to receiving the indication from the second electronic device, restricting access to the first subset of the plurality of features. Additionally or alternatively, in some embodiments the method further includes, while operating in the second mode associated with the second user account, while connected to an internet connection, allowing access to the first subset of the plurality of features; and in accordance with detecting that the internet connection is disconnected, restricting access to the first subset of the plurality of features. Additionally or alternatively, in some embodiments the method further includes while operating in the second mode associated with the second user account, transmitting, to a second electronic device associated with the user account, an indication that the second user is accessing the electronic device in the second mode. Additionally or alternatively, in some embodiments the one or more second criteria include a criterion that is satisfied when a mobile device associated with the second user account is in communication with the electronic device, wherein the mobile device associated with the second user account is a smartphone or a wearable device that does not include a head-mounted display, and wherein the electronic device includes a head-mounted display. Additionally or alternatively, in some embodiments the mobile device is the wearable device, and the one or more second criteria include a criterion that is satisfied when the second user is wearing the wearable device and is not satisfied when the second user is not wearing the wearable device.

Some embodiments are directed to a non-transitory computer readable storage medium storing instructions, which when executed by an electronic device that includes memory and one or more processors coupled to the memory, cause the electronic device to perform one or more method(s), process(es), and/or step(s) described herein.

What is claimed is:

1. An electronic device comprising:
memory; and
one or more processors coupled to the memory, the one or more processors configured to:
while operating in a first mode associated with a user account of the electronic device:
while access to a plurality of features is restricted, detect that one or more first criteria are satisfied; and
in accordance with detecting that the one or more first criteria are satisfied, allow access to the plurality of features; and
while operating in a second mode different from the first mode, the second mode associated with a second user account different from the user account of the electronic device:
while access to the plurality of features is restricted, detect that one or more second criteria are satisfied, the one or more second criteria different from the one or more first criteria; and
in accordance with detecting that the one or more second criteria are satisfied, allow access to a first subset of the plurality of features while continuing to restrict access to a second subset of the plurality of features.

2. The electronic device of claim 1, wherein the one or more processors are further configured to:
while operating in the first mode associated with the user account of the electronic device:
while allowing access to the plurality of features, detect one or more third criteria are satisfied, the one or more third criteria different from the one or more first criteria and different form the one or more second criteria; and
in accordance with detecting that the one or more third criteria are satisfied, restrict access to the plurality of features without a delay of a predetermined time period; and
while operating in the second mode associated with the second user account:
while allowing access to the first subset of the plurality of features, detect the one or more third criteria are satisfied; and
in accordance with detecting that the one or more third criteria are satisfied, restrict access to the first subset of the plurality of features after the delay of the predetermined time period.

3. The electronic device of claim 1, further comprising one or more input devices, wherein the one or more processors are further configured to, while operating in the first mode associated with the user account of the electronic device:
receive, using the one or more input devices, an input corresponding to a request to enable the second user account to access the electronic device in the second mode.

4. The electronic device of claim 1, wherein the one or more first criteria include a criterion that is satisfied when the user account is authenticated using a first authentication modality, and the one or more second criteria include a criterion that is satisfied when the second user account is authenticated using a second authentication modality different from the first authentication modality.

5. The electronic device of claim 1, wherein the one or more processors are configured to:
while operating in the second mode associated with the second user account:
while access to the first subset of the plurality of features is enabled, receive, from a second electronic device associated with the user account of the electronic device, an indication corresponding to a request to restrict access to the first subset of the plurality of features; and
in response to receiving the indication from the second electronic device, restrict access to the first subset of the plurality of features.

6. The electronic device of claim 1, wherein the one or more processors are further configured to:
while operating in the second mode associated with the second user account:
while connected to an internet connection, allow access to the first subset of the plurality of features; and
in accordance with detecting that the internet connection is disconnected, restrict access to the first subset of the plurality of features.

7. The electronic device of claim 1, wherein the one or more processors are further configured to:
while operating in the second mode associated with the second user account, transmit, to a second electronic device associated with the user account, an indication that the second user is accessing the electronic device in the second mode.

8. The electronic device of claim 1, further comprising a head-mounted display, wherein the one or more second criteria include a criterion that is satisfied when a mobile device associated with the second user account is in communication with the electronic device, wherein the mobile device associated with the second user account is a smartphone or a wearable device that does not include a head-mounted display.

9. The electronic device of claim 8, wherein the mobile device is the wearable device, and the one or more second criteria include a criterion that is satisfied when the second user is wearing the wearable device and is not satisfied when the second user is not wearing the wearable device.

10. A method performed at an electronic device that includes memory and one or more processors coupled to the memory, the method comprising:
while operating in a first mode associated with a user account of the electronic device:
while access to a plurality of features is restricted, detecting that one or more first criteria are satisfied; and
in accordance with detecting that the one or more first criteria are satisfied, allowing access to the plurality of features; and
while operating in a second mode different from the first mode, the second mode associated with a second user account different from the user account of the electronic device:
while access to the plurality of features is restricted, detecting that one or more second criteria are satisfied, the one or more second criteria different from the one or more first criteria; and
in accordance with detecting that the one or more second criteria are satisfied, allowing access to a first subset of the plurality of features while continuing to restrict access to a second subset of the plurality of features.

11. The method of claim 10, further comprising:
while operating in the first mode associated with the user account of the electronic device:
while allowing access to the plurality of features, detecting one or more third criteria are satisfied, the one or more third criteria different from the one or more first criteria and different form the one or more second criteria; and
in accordance with detecting that the one or more third criteria are satisfied, restricting access to the plurality of features without a delay of a predetermined time period; and
while operating in the second mode associated with the second user account:
while allowing access to the first subset of the plurality of features, detecting the one or more third criteria are satisfied; and
in accordance with detecting that the one or more third criteria are satisfied, restricting access to the first subset of the plurality of features after the delay of the predetermined time period.

12. The method of claim 10, further comprising, while operating in the first mode associated with the user account of the electronic device:
receiving, using one or more input devices, an input corresponding to a request to enable the second user account to access the electronic device in the second mode.

13. The method of claim 10, wherein the one or more first criteria include a criterion that is satisfied when the user account is authenticated using a first authentication modality, and the one or more second criteria include a criterion that is satisfied when the second user account is authenticated using a second authentication modality different from the first authentication modality.

14. The method of claim 10, further comprising:
while operating in the second mode associated with the second user account:
while access to the first subset of the plurality of features is enabled, receiving, from a second electronic device associated with the user account of the electronic device, an indication corresponding to a request to restrict access to the first subset of the plurality of features; and
in response to receiving the indication from the second electronic device, restricting access to the first subset of the plurality of features.

15. The method of claim 10, further comprising:
while operating in the second mode associated with the second user account:
while connected to an internet connection, allowing access to the first subset of the plurality of features; and
in accordance with detecting that the internet connection is disconnected, restricting access to the first subset of the plurality of features.

16. The method of claim 10, further comprising:
while operating in the second mode associated with the second user account, transmitting, to a second electronic device associated with the user account, an indication that the second user is accessing the electronic device in the second mode.

17. The method of claim 10, wherein the one or more second criteria include a criterion that is satisfied when a mobile device associated with the second user account is in communication with the electronic device, wherein the mobile device associated with the second user account is a smartphone or a wearable device that does not include a head-mounted display, and wherein the electronic device includes a head-mounted display.

18. The method of claim 17, wherein the mobile device is the wearable device, and the one or more second criteria include a criterion that is satisfied when the second user is wearing the wearable device and is not satisfied when the second user is not wearing the wearable device.

19. A non-transitory computer readable storage medium storing instructions, which when executed by an electronic device that includes memory and one or more processors coupled to the memory, cause the electronic device to perform a method comprising:
while operating in a first mode associated with a user account of the electronic device:
while access to a plurality of features is restricted, detecting that one or more first criteria are satisfied; and
in accordance with detecting that the one or more first criteria are satisfied, allowing access to the plurality of features; and
while operating in a second mode different from the first mode, the second mode associated with a second user account different from the user account of the electronic device:
while access to the plurality of features is restricted, detecting that one or more second criteria are satisfied, the one or more second criteria different from the one or more first criteria; and
in accordance with detecting that the one or more second criteria are satisfied, allowing access to a first subset of the plurality of features while continuing to restrict access to a second subset of the plurality of features.
